(19) United States
(12) Patent Application Publication
(10) Pub. No.: US 2026/0147871 A1
(43) Pub. Date: May 28, 2026

(54) SEMICONDUCTOR DEVICE AND CERTIFICATION METHOD THEREOF

(71) Applicant: Renesas Electronics Corporation, Tokyo (JP)

(72) Inventor: Takahiko SUGAHARA, Tokyo (JP)

(21) Appl. No.: 19/349,037

(22) Filed: Oct. 3, 2025

(30) Foreign Application Priority Data
Nov. 22, 2024 (JP) 2024-203944

(51) Int. Cl. G06F 21/44; G06F 18/22

(52) U.S. Cl. CPC G06F 21/44; G06F 18/22

(57) ABSTRACT

Improve the tamper resistance against physical attacks on semiconductor devices. The semiconductor device according to the present disclosure includes a transition circuit that transitions the state at a predetermined Hamming distance based on the comparison result between the certification target value and the reference value, and a determination circuit that determines the validity of the certification by determining whether the Hamming distance between the state before the transition and the state after the transition matches the predetermined Hamming distance.

### CROSS-REFERENCE TO RELATED APPLICATIONS

The disclosure of Japanese Patent Application No. 2024-203944 filed on Nov. 22, 2024, including the specification, drawings and abstract is incorporated herein by reference in its entirety.

### BACKGROUND

The present disclosure relates to a semiconductor device and a certification method, for example, a semiconductor device and a certification method for determining the validity of certification.

Cryptographic technology for secure communication or data confidentiality is widely used in familiar information devices such as IC (Integrated Circuit) cards. Recently, the importance of cryptographic technology has also been increasing in ECUs (Electronic Control Units) that electronically control various parts inside automobiles. In particular, the threat of exploiting functions not supported for customer use (hereinafter also referred to as unsupported functions) is becoming more serious. Unsupported functions include, for example, test functions or debugging functions used in the semiconductor development phase. Generally, measures to protect against threats are taken using the security functions of semiconductor devices. An example of a security function is ID (identification) certification.

However, there is a possibility that unsupported functions may be exploited due to the tampering of certification flags through physical attacks targeting physical vulnerabilities. Physical attacks include, for example, fault injection attacks such as power glitches, clock glitches, or electromagnetic radiation.

FIG. 1 shows an example of a fault injection attack. The ID certification mechanism shown in FIG. 1 includes a comparator and an FF (Flip-Flop). The comparator receives an ID input value and an ID expected value. The ID input value is a value entered during certification, such as a password or certification code. The ID expected value is a value against which the ID input value is compared to execute certification. The comparator compares the ID input value and the ID expected value bit by bit. The comparator outputs a voltage indicating the comparison result for each bit. The output from the comparator is input to the FF as data. The FF outputs a certification flag indicating assert or negate according to the output from the comparator input for each bit. At this time, if a fault injection attack is made on the FF, the FF outputs assert as the certification flag regardless of the output from the comparator. Based on the certification flag indicating assert, entry to unsupported functions is made. In this way, there was a possibility that unsupported functions could be exploited due to incorrect certification caused by an attack.

There are disclosed techniques listed below.
[Non-Patent Document 1] D. El-Baze, J.-B. Rigaud, and P. Maurine (2016). A Fully-Digital EM Pulse Detector. In Design, Automation & Test in Europe Conference & Exhibition (DATE), pages 439-444. IEEE, 2016

As related technology, Non-Patent Document 1 discloses a digital detector that detects electromagnetic pulse injection, which is an example of fault injection.

### SUMMARY

It is required to improve the tamper resistance against physical attacks on semiconductor devices. Other issues and novel features will become apparent from the description of this specification and the accompanying drawings.

A semiconductor device according to one aspect of the present disclosure includes a transition circuit that transitions a state at a predetermined Hamming distance according to the comparison result of a certification target value and a reference value, and a determination circuit that determines the validity of certification by determining whether the Hamming distance between the state before transition and the state after transition matches the predetermined Hamming distance.

The certification method of a semiconductor device according to one aspect of the present disclosure includes transitioning a state at a predetermined Hamming distance according to the comparison result of a certification target value and a reference value and determining the validity of certification by determining whether the Hamming distance between the state before transition and the state after transition matches the predetermined Hamming distance.

The present disclosure can provide a test method and an information processing device for a semiconductor device that can improve tamper resistance against physical attacks on semiconductor devices.

### BRIEF DESCRIPTION OF THE DRAWINGS

FIG. 1 is a diagram showing an example of a fault injection attack.

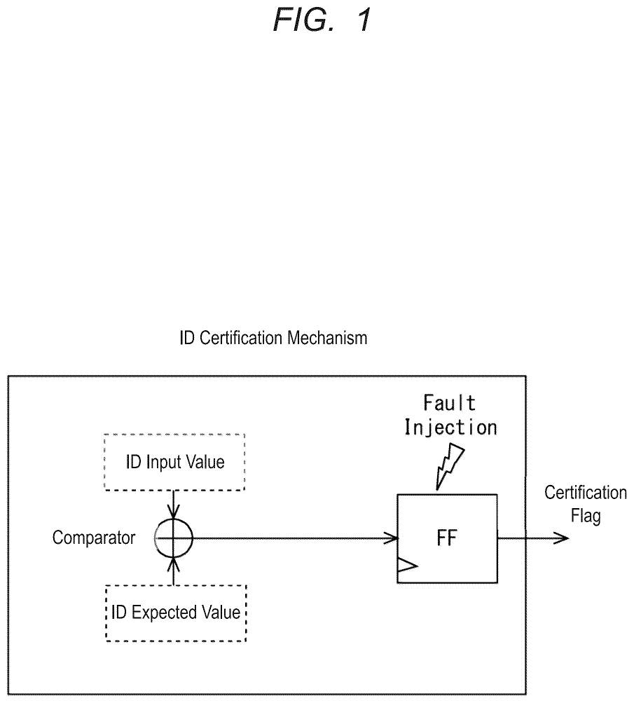

FIG. 2 is a diagram showing an example where a binary counter transitions a 4-bit state.

FIG. 3 is a diagram showing an example where a Johnson counter transitions a 3-bit state.

FIG. 4 is a block diagram illustrating a configuration example of a semiconductor device according to the first embodiment.

FIG. 5 is a flowchart illustrating an example of a representative process of a semiconductor device according to the first embodiment.

FIG. 6 is a block diagram illustrating a configuration example of a semiconductor device according to the second embodiment.

FIG. 7 is a block diagram illustrating a configuration example of a certification function IP according to the second embodiment.

FIG. 8 is a timing chart illustrating an example of the operation of a semiconductor device according to the second embodiment.

FIG. 9 is a block diagram illustrating a configuration example of a semiconductor device according to the third embodiment.

FIG. 10 is a block diagram illustrating a configuration example of a certification function IP according to the third embodiment.

FIG. 11 is a timing chart illustrating an example of the operation of a semiconductor device according to the third embodiment.

### DETAILED DESCRIPTION

Below, the embodiments will be described with reference to the drawings. Note that the drawings are described in a simplified manner. The technical scope of the embodiments should not be narrowly interpreted based on the descriptions in the drawings. Also, the same elements in multiple drawings are denoted by the same reference numerals. Redundant descriptions are omitted as appropriate.

In the following embodiments, explanations may be divided into multiple sections or embodiments for convenience if necessary. However, unless specifically stated otherwise, the multiple sections or embodiments are not unrelated to each other. One section or embodiment may be related to another section or embodiment as a modification, application, detailed explanation, or supplementary explanation of part or all of the other. Furthermore, in the following embodiments, when referring to the number of elements (including quantity, numerical values, amounts, ranges, etc.), unless specifically stated otherwise, the number of elements is not limited to a specific number. The configurations or processes shown in each embodiment can be combined with the configurations or processes shown in other embodiments as appropriate.

Furthermore, in the following embodiments, the components (including operation steps) are not essential unless specifically stated otherwise or considered obviously essential in principle. The shape or positional relationship of the components includes those that are approximate or similar to the mentioned shape or positional relationship unless specifically stated otherwise. The number of elements (including quantity, numerical values, amounts, ranges, etc.) also includes numbers that are approximate or similar to the mentioned number unless specifically stated otherwise.

### Explanation of the Premise of the Disclosure

Below, the relationship between attacks and the Hamming distance of states in this disclosure will be explained. The Hamming distance is the number of positions at which the corresponding symbols are different when bit strings of the same length are compared. In this disclosure, the following is assumed as the attack capability of an attacker against a semiconductor device. The attacker can induce bit errors in data with multiple bit values in a single attack. A bit error means a process of illegally rewriting (tampering with) a bit value of 1 in the data or multiple bit values of the same value in the data to a different bit value. For example, a bit error means tampering with one or more “0” in the data to “1” or tampering with one or more “1” in the data to “0”. However, the attacker cannot illegally rewrite each bit value of multiple different values in the data in a single attack. For example, assuming the data to be attacked is “F0h”. In this case, the attacker can tamper with the data to “00h” or “FFh” in a single attack. However, the attacker cannot tamper with the data to “0Fh” in a single attack. In this disclosure, the above-described attack is assumed as a realistically conceivable attack.

Also, in this disclosure, a state machine that transitions states with a predetermined Hamming distance in response to external input is assumed. The predetermined Hamming distance is any integer of 1 or more. As specific examples of realizing a state machine, a binary counter and a Johnson counter are mentioned here. However, other types of counters (for example, Gray code counters) may be used as counters. Also, the Hamming distance by which the counter transitions states is not limited to 1 or 2. The Hamming distance may be any distance of 3 or more. Furthermore, the number of transitions until the state returns to the initial state by repeating transitions is arbitrary.

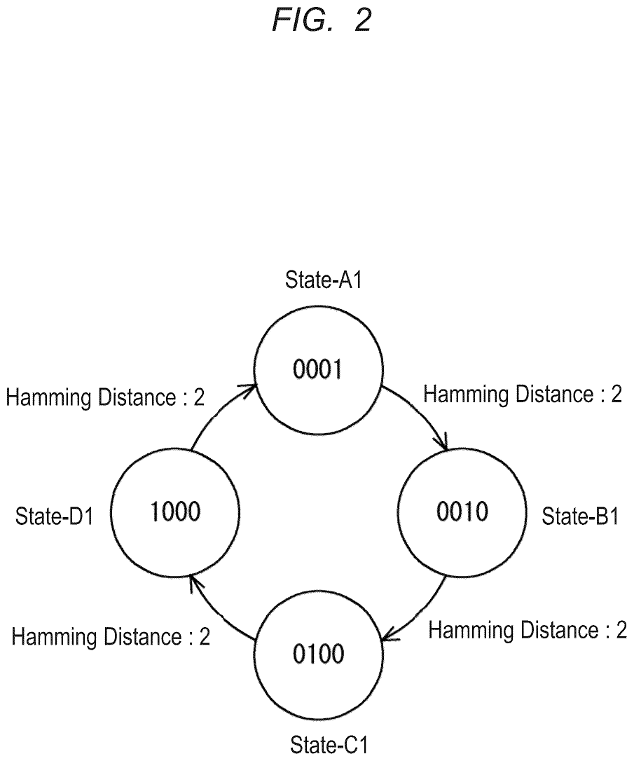

FIG. 2 is a diagram showing an example where a binary counter transitions a 4-bit state. (a1) Initially, the binary counter transitions the state from the initial state A1 “0001” to state B1 “0010” in response to external input. (b1) Next, the binary counter transitions the state from state B1 “0010” to state C1 “0100” in response to external input. (c1) Next, the binary counter transitions the state from state C1 “0100” to state D1 “1000” in response to external input. (d1) Next, the binary counter transitions the state from state D1 “1000” to state A1 “0001” in response to external input. Note that the states A1 and B1, B1 and C1, C1 and D1, D1 and A1 are each separated by a Hamming distance of “2”. Subsequently, when there is an external input, the binary counter returns to (a1) and executes the state transition.

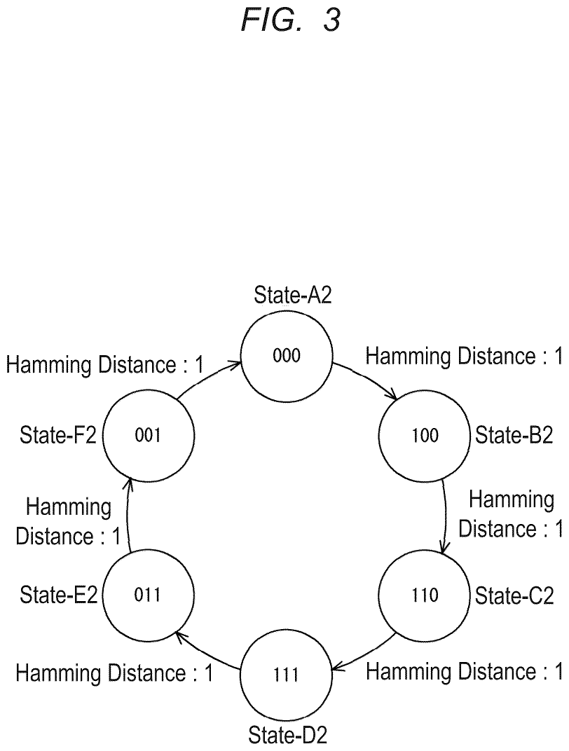

FIG. 3 is a diagram showing an example where a Johnson counter transitions a 3-bit state. (a2) Initially, the Johnson counter transitions the state from the initial state A2 “000” to state B2 “100” in response to external input. (b2) Next, the Johnson counter transitions the state from state B2 “100” to state C2 “110” in response to external input. (c2) Next, the Johnson counter transitions the state from state C2 “110” to state D2 “111” in response to external input. (d2) Next, the Johnson counter transitions the state from state D2 “111” to state E2 “011” in response to external input. (e2) Next, the Johnson counter transitions the state from state E2 “011” to state F2 “001” in response to external input. (f2) Next, the Johnson counter transitions the state from state F2 “001” to state A2 “000” in response to external input. Note that the states A2 and B2, B2 and C2, C2 and D2, D2 and E2, E2 and F2, F2 and A2 are each separated by a Hamming distance of “1”. Subsequently, when there is an external input, the Johnson counter returns to (a2) and executes the state transition.

In this disclosure, by utilizing the characteristics of the counters shown above, the integrity of certification against attacks is improved. As a specific example, assume that an attack is executed on the binary counter shown in FIG. 2. Here, two types of bit errors caused by the attack are assumed. (A) When a bit error can occur only at the bit position where the bit change of the state occurs during the state transition (B) When a bit error can occur at all bit positions of the state during the state transition.

First, consider (A). In FIG. 2, the bit positions of the state that change when transitioning from state A “0001” to state B “0010” are bit0 and bit1. As the first case, assume that the attacker induces an attack that causes a bit of an error, changing the bit value “1” to “0”. In this case, since there is a “1” in bit0 of state A, state A “0001” is tampered to state “0000”. The Hamming distance between state A and the tampered state is “1”. As the second case, assume that the attacker induces an attack that causes a bit error changing the bit value “1” to “0”. In this case, since there is a “0” in bit1 of state A, state A “0001” is tampered to state “0011”. The Hamming distance between state A and the tampered state is “1”. Therefore, in both the first and second cases, the Hamming distance between the tampered state and the original state A deviates from the Hamming distance “2” that should originally be satisfied.

In the first case of (B), assume that the attacker induces an attack that causes a bit error changing the bit value “1” to “0”. This attack is executed when transitioning from state A “0001” to state B “0010” in FIG. 2. In this case, state A “0001” is tampered to state “0000”. The Hamming distance between state A and the tampered state is “1”. As the second case, assume that the attacker induces an attack that causes a bit error changing the bit value “0” to “1”. State A “0001” is tampered to state “1111”. The Hamming distance between state A and the tampered state is “3”. Therefore, in both the first and second cases, the Hamming distance between the tampered state and the original state A deviates from the Hamming distance “2” that should originally be satisfied.

In the case of (A) or (B), assume the existence of a circuit that compares the Hamming distance between the state before transition and the state after transition with the Hamming distance that should originally be satisfied. At this time, the circuit can determine that the data has been illegally tampered with by the attacker by determining that the Hamming distance between the two states and the Hamming distance that should originally be satisfied are different. In FIG. 2, even in transitions other than the transition from state A to state B, the circuit can compare the Hamming distance in the case of tampering with the Hamming distance that should originally be satisfied. The circuit can determine the presence or absence of tampering by the attacker using the result of the comparison.

### First Embodiment

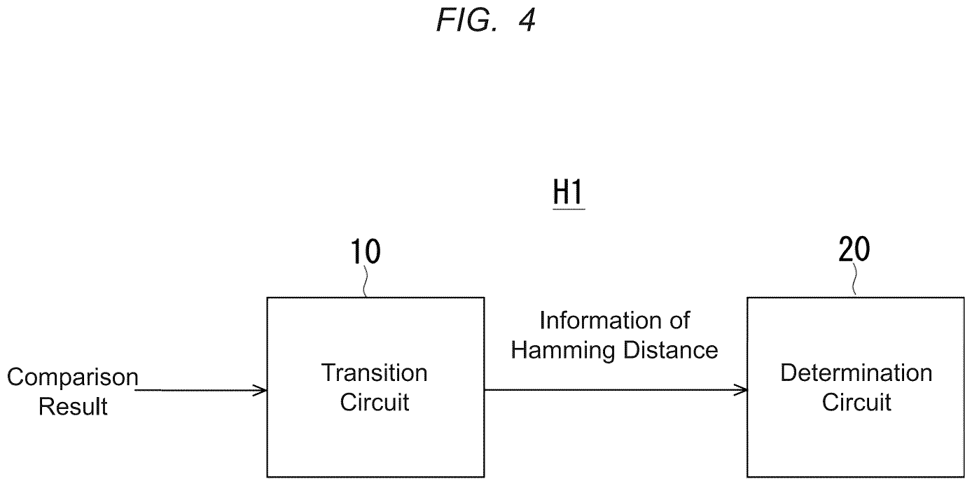

FIG. 4 is a block diagram showing a configuration example of a semiconductor device H1 according to the first embodiment. The semiconductor device H1 includes a transition circuit 10 and a determination circuit 20.

The transition circuit 10 receives the comparison result of the certification target value and the reference value. The certification target value is a value of one or more bits to be certificated. The reference value has the same number of bits as the target value. The reference value is a value for which certification is executed by being compared with the target value. The comparison result indicates whether all or part of the target value and all or part of the reference value have the same value. For example, each of the target value and the reference value may be divided into a predetermined bit length. The comparison result may indicate the result of comparing the divided bit value of the target value with the divided bit value of the reference value corresponding to the divided bit value of the target value, for each divided bit value.

The transition circuit 10 transitions the state with a predetermined Hamming distance according to the comparison result. The predetermined Hamming distance is, for example, a Hamming distance specific to the counter constituting the transition circuit 10. The predetermined Hamming distance is any Hamming distance of 1 or more. The transition circuit 10 outputs the information of the state before the transition and the information of the state after the transition to the determination circuit 20.

The determination circuit 20 determines the validity of the certification by determining whether the Hamming distance between the state before the transition and the state after the transition matches the predetermined Hamming distance. As stated in the “Premise Description of the Present Disclosure,” if an attack is made on the transition circuit 10, it is considered that the Hamming distance transitioned by the transition circuit 10 does not match the predetermined Hamming distance. Therefore, if the Hamming distance transitioned by the transition circuit 10 does not match the predetermined Hamming distance, the determination circuit 20 determines that the certification is not valid. On the other hand, if the Hamming distance transitioned by the transition circuit 10 matches the predetermined Hamming distance, the determination circuit 20 determines that the certification is valid.

### Description of Processing Flow

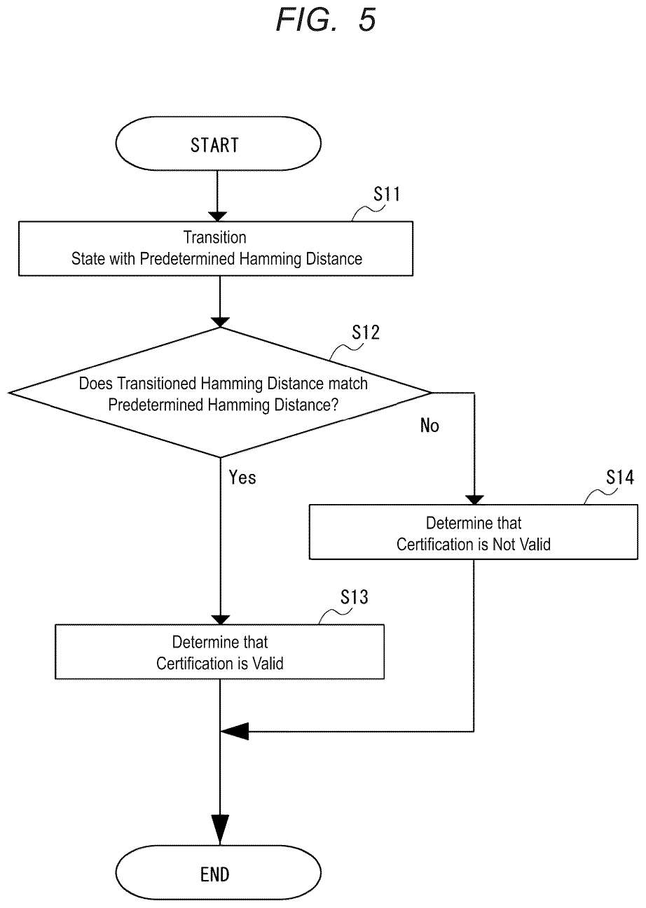

FIG. 5 is a flowchart showing an example of typical processing of the semiconductor device H1. With reference to the flowchart of FIG. 5, an overview of the processing of the semiconductor device H1 is described. Note that the description of parts already explained for each process is appropriately omitted.

First, the transition circuit 10 transitions the state with a predetermined Hamming distance according to the comparison result of the certification target value and the reference value (step S11). The determination circuit 20 determines whether the Hamming distance between the state before the transition and the state transitioned in step S11 matches the predetermined Hamming distance (step S12). If the Hamming distance in the transition matches the predetermined Hamming distance (“Yes” in step S12), the determination circuit 20 determines that the certification is valid (step S13). If the Hamming distance in the transition does not match the predetermined Hamming distance (“No” in step S12), the determination circuit 20 determines that the certification is not valid (step S14).

### Explanation of Effects

The determination circuit 20 determines the validity of the certification by determining whether the Hamming distance between the state before the transition and the state after the transition matches the predetermined Hamming distance. As stated in the “Premise Description of the Present Disclosure,” if a realistically assumed attack is made, it is considered that the Hamming distance between the state before the transition and the state after the transition does not match the predetermined Hamming distance. Therefore, the semiconductor device H1 can accurately determine the validity of the certification. In other words, the semiconductor device H1 can improve tamper resistance against physical attacks.

The following embodiments disclose specific examples of the semiconductor device H1 described in the first embodiment. However, the specific examples of the semiconductor device H1 shown in the first embodiment are not limited to those shown below. Also, the configuration and processing of the semiconductor device H1 described below are illustrative and are not limited.

### Second Embodiment

### Description of Configuration

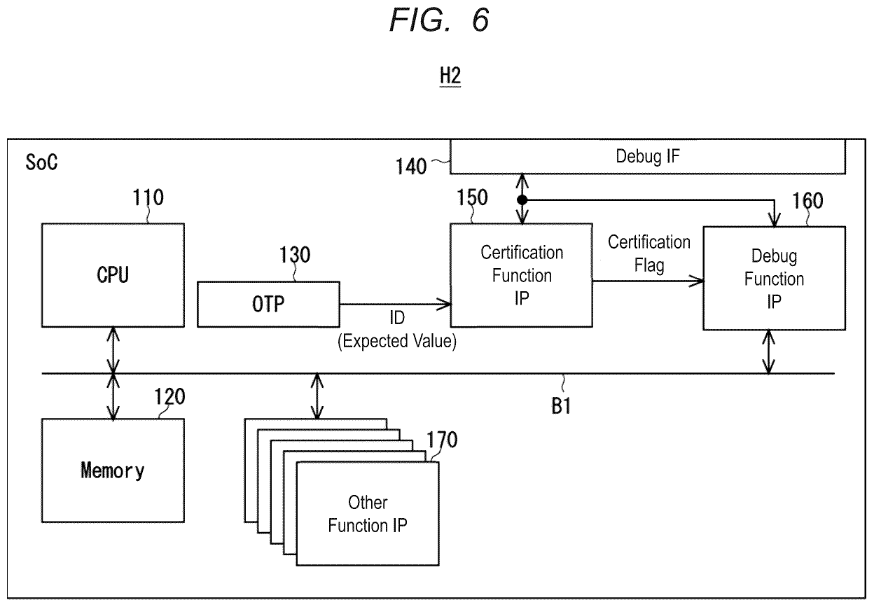

FIG. 6 is a block diagram showing a configuration example of the semiconductor device H2 according to the second embodiment. The semiconductor device H2 is mounted on a substrate as an SoC (System on a Chip). The semiconductor device H2 includes a CPU (Central Processing Unit) 110, a memory 120, an OTP (One Time Programmable) 130, a debug IF (Interface) 140, a certification function IP (Intellectual Property) 150, a debug function IP 160, and other function IP 170. The following describes each part of the semiconductor device H2.

The CPU 110 controls the operation of the debug function IP 160 and other function IP 170 by executing the program stored in memory 120. The CPU 110 controls the operation of the debug function IP 160 and other function IP 170 by outputting control signals via bus B1.

The OTP 130 stores the expected ID value for certification. The expected ID value is a pre-set 8-bit (1-byte) value. It serves as a reference value that is compared with the input ID value (input ID value) by the certification function IP 150. OTP 130 outputs the expected ID value to the certification function IP 150.

The debug IF 140 receives the ID value input for certification to the semiconductor device H2. The input ID value is an 8-bit target value that is compared with the ID reference value. However, the number of bits for the input ID value and the ID reference value is not limited to 8 bits. The input ID value and the ID reference value may have any number of bits. The debug IF 140 outputs the input ID value to the certification function IP 150 and the debug function IP 160.

The certification function IP 150 compares the input ID value with the expected ID value. Based on the comparison result, the certification function IP 150 changes whether to enable or disable the certification flag. If the certification flag is enabled, the certification function IP 150 outputs an assert certification flag. If the certification flag is disabled, the certification function IP 150 outputs a negate certification flag. A detailed description of the certification function IP 150 will be provided later.

The debug function IP 160 executes debugging based on the input ID value and the certification flag. If the certification flag is asserted, the debug function IP 160 allows entry to the debug function. On the other hand, if the certification flag is negated, the debug function IP 160 disallows entry to the debug function. The other function IP 170 executes functions other than the certification function.

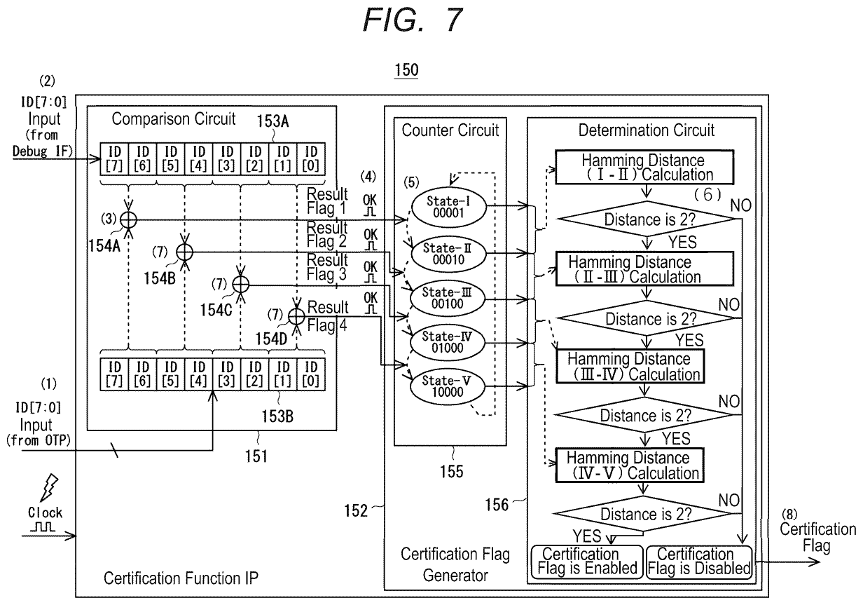

FIG. 7 is a block diagram showing an example configuration of the certification function IP 150. The certification function IP 150 receives the input ID value, the expected ID value, and a clock signal. The certification function IP 150 includes a comparison circuit 151 and a certification flag generator 152. The following describes each part of the certification function IP 150.

The comparison circuit 151 includes memories 153A and 153B, and comparators 154A to 154D. The input ID value from the debug IF 140 is input to the memory 153A. The expected ID value from the OTP 130 is input to the memory 153B. Memory 153A stores the expected ID value by bit number. Memory 153B stores the expected ID value by bit number.

The comparator 154A receives the bits at bit numbers [7] and [6] in the memory 153A and the bits at bit numbers [7] and [6] in the memory 153B. The comparator 154B receives the bits at bit numbers [5] and [4] in the memory 153A and the bits at bit numbers [5] and [4] in the memory 153B. The comparator 154C receives the bits at bit numbers [3] and [2] in the memory 153A and the bits at bit numbers [3] and [2] in the memory 153B. The comparator 154A receives the bits at bit numbers [1] and [0] in the memory 153A and the bits at bit numbers [1] and [0] in the memory 153B. In this way, each comparator 154 receives the bit values of a predetermined portion of the input ID value and the bit values of the corresponding predetermined portion of the expected ID value. Furthermore, each comparator 154 receives the bit value of the input ID value divided into the same 2-bit length and the bit values of the expected ID value divided into the same 2-bit length.

The comparator 154A compares the 2-bit value of the input ID value with the 2-bit value of the expected ID value. If each input bit value matches, the comparator 154A transfers a comparison result flag indicating assert to the certification flag generator 152. If each input bit value does not match, the comparator 154A transfers a comparison result flag indicating negate to the certification flag generator 152. Each comparator 154 other than the comparator 154A also compares the 2-bit value of the input ID value with the 2-bit value of the expected ID value. If each input bit value matches, each comparator 154 transfers a comparison result flag indicating assert to the certification flag generator 152. If each input bit value does not match, each comparator 154 transfers a comparison result flag indicating negate to the certification flag generator 152. Hereinafter, the comparison result flag indicating assert output by comparator 154A is referred to as assert flag A, and the comparison result flag indicating assert output by comparator 154B is referred to as assert flag B. Similarly, the comparison result flag indicating assert output by the comparator 154C is referred to as assert flag C, and the comparison result flag indicating assert output by the comparator 154D is referred to as assert flag D.

In FIG. 7, each comparator 154 outputs a high-active signal as a comparison result flag indicating assert. However, each comparator 154 may output a low-active signal as a comparison result flag indicating assert. As a variation, each comparator 154 may compare the 1-bit value of the input ID value with the 1-bit value of the expected ID value. As another example, each comparator 154 may compare multiple values of 3 bits or more of the input ID value with multiple values of 3 bits or more of the expected ID value. Furthermore, the number of bits of the input ID value and the expected ID value compared by each comparator 154 need not be the same.

The certification flag generator 152 includes a counter circuit 155 and a determination circuit 156. The counter circuit 155 has a binary counter that transitions a 5-bit state. The counter circuit 155 functions as a state machine that transitions the state with a Hamming distance of “2”. The state transitions are shown below.

(i) Initially, when the counter circuit 155 receives assert flag A, it transitions the state from state I “00001” to state II “00010”, which is a Hamming distance of “2” away. Note that state I is the initial state. (ii) Next, when the counter circuit 155 receives assert flag B, it transitions the state from state II “00010” to state III “00100”, which is a Hamming distance of “2” away. (iii) Next, when the counter circuit 155 receives assert flag C, it transitions the state from state III “00100” to state IV “01000”, which is a Hamming distance of “2” away. (iv) Next, when the counter circuit 155 receives assert flag D, it transitions the state from state IV “01000” to state V “10000”, which is a Hamming distance of “2” away. When the counter circuit 155 transitions the state-to-state V “10000”, it returns the state to state I “00001”. Thereafter, when the counter circuit 155 receives assert flag A, it returns to (i) and executes the state transition. However, when the counter circuit 155 receives a comparison result flag indicating negate, it does not execute the state transition. The Hamming weight of states I to V is all “1”. Note that the Hamming weight of a state indicates the number of “1” bits in the state.

The counter circuit 155 transitions the state with a predetermined Hamming distance according to the comparison result of each comparator 154. When the state transitions in any of (i) to (iv), the counter circuit 155 outputs the information of the state after the transition to the determination circuit 156. Note that the information of state I, which is the initial state, is stored in the determination circuit 156 in advance.

The determination circuit 156 receives information about the post-transition state from the counter circuit 155 when the state transitions in any of (i) to (iv). The determination circuit 156 calculates the Hamming distance between the pre-transition state and the post-transition state. The determination circuit 156 determines whether the calculated Hamming distance is 2.

If it is determined that the Hamming distance is 2 in any of (i) to (iii), the determination circuit 156 judges that the state transition has been performed correctly. The determination circuit 156 remains in a standby state without executing any process until the next state transition occurs. If it is determined that the Hamming distance is 2 in (iv), the determination circuit 156 judges that the certification flag is valid. On the other hand, if it is determined that the Hamming distance is not 2 in any of (i) to (iv), the determination circuit 156 judges that the state transition has been performed incorrectly. Specifically, the determination circuit 156 judges that the state transition has been performed incorrectly due to a fault injection attack on the clock signal. Then, the determination circuit 156 judges that the certification flag is invalid. In this way, the determination circuit 156 judges the integrity of the certification.

If it is determined that the certification flag is valid, the certification function IP150 outputs an assert as the certification flag. On the other hand, if it is determined that the certification flag is invalid, the certification function IP150 outputs a negate as the certification flag. When the certification flag is asserted, entry to a predetermined function of the semiconductor device H2 becomes possible. On the other hand, when the certification flag is negated, entry to a predetermined function of the semiconductor device H2 becomes impossible. Therefore, in the event of a fault injection attack, the semiconductor device H2 can prevent entry to the predetermined function.

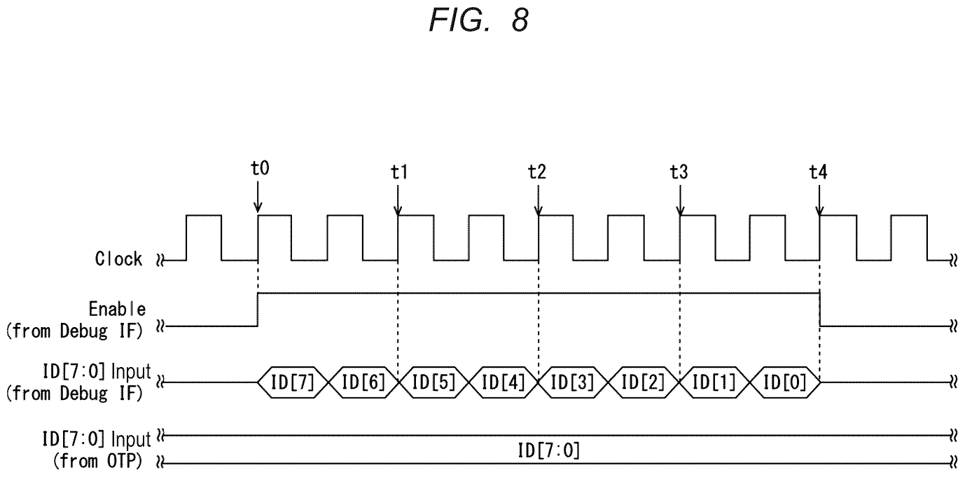

FIG. 8 is a timing chart showing an example of the operation of the semiconductor device H2. Hereinafter, the operation of the semiconductor device H2 along the time series will be described with reference to FIGS. 7 and 8. (1) to (8) in FIG. 7 correspond to the codes (1) to (8) below. Note that the operation of each part that has already been described will be omitted as appropriate.

(1) First, the power supply of the semiconductor device H2 is activated. A clock signal for operation is supplied to the semiconductor device H2. After the power supply is activated, the ID expected value stored in OTP130 is loaded into the certification function IP 150. The ID expected value is stored in the memory 153A.

(2) Also, the input ID value is input to the certification function IP 150 via the debug IF140. After timing t0 in FIG. 8, the enable signal for loading from the debug IF 140 to the memory 153B turns on. In response to the enable signal turning on, the input ID value is stored bit by bit in the memory 153B.

(3) Each bit value of the input ID value and each corresponding bit value of the ID expected value are input to the comparator 154 of the certification function IP 150 every clock. From timing t0 to t1, the 2-bit value of the input ID value and the 2-bit value of the corresponding ID expected value are input to the comparator 154A. The comparator 154A compares the input 2-bit values at timing t1.

(4) If the input bit values match, the comparator 154A transfers a comparison result flag (assert flag A) indicating an assert to the certification flag generator 152. If the input data does not match, the comparator 154A transfers a comparison result flag indicating a negate to the certification flag generator 152.

(5) When the counter circuit 155 receives the assert flag A, it transitions the state from state I “00001” to state II “00010,” which is a Hamming distance of “2” away. The counter circuit 155 outputs the information of state II to the determination circuit 156.

(6) The determination circuit 156 receives the information of state II as the post-transition state information from the counter circuit 155. The determination circuit 156 calculates the Hamming distance between the pre-transition state, state I, and the post-transition state, state II. The determination circuit 156 determines whether the calculated Hamming distance is 2. If it is determined that the Hamming distance is 2, the determination circuit 156 judges that the state transition has been performed correctly. The determination circuit 156 remains in a standby state without executing any process until the next state transition occurs. On the other hand, if it is determined that the Hamming distance is not 2, the determination circuit 156 judges that the state transition has been performed incorrectly. Then, the determination circuit 156 judges that the certification flag is invalid.

(7) Assuming that it is determined in (6) that the state transition has been performed correctly, the comparator 154B performs the same processing as the comparator 154A shown in (3) and (4). The comparator 154B compares the input 2-bit values at timing t2. Subsequently, the counter circuit 155 performs the same processing as shown in (5) in response to receiving the assert flag B. When determination circuit 156 receives the information of state III as the post-transition state information, it performs the same processing as shown in (6). The same processing as shown in (3) to (6) is executed for the comparators 154C and 154D. The comparator 154C compares the input 2-bit values at timing t3. Also, the comparator 154D compares the input 2-bit values at timing t4.

Note that after timing t4, the enable signal for loading from the debug IF 140 to the memory 153B turns off. In response to the enable signal turning off, the storage of the input ID value in the memory 153B is stopped.

When the processing of (7) is executed for the comparator 154D, the determination circuit 156 calculates the Hamming distance between the pre-transition state, state IV, and the post-transition state, state V. The determination circuit 156 determines whether the calculated Hamming distance is 2. If it is determined that the Hamming distance is 2, the determination circuit 156 judges that the certification flag is valid. On the other hand, if it is determined that the Hamming distance is not 2, the determination circuit 156 judges that the state transition has been performed incorrectly.

(8) If it is determined that the certification flag is valid, the certification function IP 150 outputs an assert as the certification flag. On the other hand, if it is determined that the certification flag is invalid, the certification function IP 150 outputs a negate as the certification flag. If the certification flag is asserted, the debug function IP 160 allows entry to the debug function. On the other hand, if the certification flag is negated, the debug function IP 160 prohibits entry to the debug function.

### Explanation of Effects

As shown above, each comparator 154 compares the bit values of the divided input ID value with the bit values of the divided ID expected value corresponding to the divided input ID value. The counter circuit 155 transitions the state by a predetermined Hamming distance according to the comparison result of each comparator 154. The determination circuit 156 can determine whether the Hamming distance of the state transition matches the predetermined Hamming distance each time the state transitions. Therefore, the semiconductor device H2 can strictly determine the validity of the certification. The semiconductor device H2 can suppress unauthorized entry to the debug function.

Furthermore, in the event of a fault injection attack, as described in the “Premise Description of the Present Disclosure,” the Hamming distance between the pre-transition state and the post-transition state tends to be “1”. If the counter circuit 155 transitions the state with a Hamming distance of “1”, the determination circuit 156 may mistakenly judge that the state transition has been performed correctly even in the event of a fault injection attack. However, the counter circuit 155 can transition the state with a Hamming distance of 2 or more. Therefore, even in the event of a fault injection attack, the determination circuit 156 can reduce the possibility of mistakenly judging that the state transition has been performed correctly.

In the above example, determination circuit 156 determines whether the state transition has been performed correctly by determining the Hamming distance between the pre-transition state and the post-transition state when the state transitions. However, the determination circuit 156 may also determine whether the state transition has been performed correctly by further using the Hamming weight of the post-transition state.

Hereinafter, a detailed explanation will be provided. The determination circuit 156 calculates the Hamming distance between the state before the transition and the state after the transition when the state transitions in any of (i) to (iv). The determination circuit 156 determines whether the calculated Hamming distance is 2. If it is determined that the Hamming distance is not 2, the determination circuit 156 judges that the state transition was made improperly.

If it is determined that the Hamming distance is 2, the determination circuit 156 further compares the Hamming weight of the actual post-transition state with the Hamming weight of the original post-transition state. In this example, the Hamming weight of the original post-transition state becomes “1”. The Hamming weight of the original post-transition state may be stored in memory within the determination circuit 156. The determination circuit 156 performs the comparison of the Hamming weight by referring to the memory. In this example, the Hamming weight of the state becomes “1” regardless of the state.

If the Hamming weight of the actual post-transition state and the Hamming weight of the original post-transition state are the same, the determination circuit 156 judges that the state transition was made correctly. The determination circuit 156 remains in a standby state without executing any process until the next state transition occurs. On the other hand, if it is determined that the Hamming weight of the actual post-transition state and the Hamming weight of the original post-transition state are not the same, the determination circuit 156 judges that the state transition was made improperly.

For example, assume a case where a fault injection attack is made when the state transitions from state I to state II. Suppose that due to the attack, the state changes from state I “00001” to state “00111”. At this time, the determination circuit 156 calculates the Hamming distance between the pre-transition state and the post-transition state as “2”. If the determination of the Hamming weight is not executed, the determination circuit 156 may incorrectly judge that the state transition was made correctly despite the attack.

However, by executing the determination of the Hamming weight, the determination circuit 156 judges that the Hamming weight of the actual post-transition state and the Hamming weight of the original post-transition state are not the same. Therefore, the determination circuit 156 can judge that the state transition was made improperly.

It is also conceivable, although unlikely, that an attack will cause bit errors to occur only in bit positions where no bit changes in the state occur. However, even in such cases, the determination circuit 156 can judge that the state transition was made improperly by executing the determination of the Hamming weight.

The determination circuit 156 may first compare the Hamming weight of the actual post-transition state with the Hamming weight of the original post-transition state. If the Hamming weight of the actual post-transition state and the Hamming weight of the original post-transition state are the same, the determination circuit 156 executes the determination of the Hamming distance. If the Hamming distance is 2, the determination circuit 156 judges that the state transition was made correctly. On the other hand, if it is determined that the Hamming weight before and after the state transition are not the same, or if the Hamming distance is not 2, the determination circuit 156 judges that the state transition was made improperly.

In this way, by executing the determination of the Hamming weight, the determination circuit 156 can more accurately judge the validity of certification in the semiconductor device H2. Therefore, the tamper resistance of the semiconductor device H2 against physical attacks is further improved.

Note that the Hamming distance by which the counter circuit 155 transitions the state is not limited to 2 and may be any integer of 1 or 3 or more. Also, the Hamming weight of all possible states that the counter circuit 155 can transition to may all be the same value. The Hamming weight of all states may be “1” as described above, or it may be a value of “2” or more. Alternatively, the Hamming weight of all possible states may have different values. However, if the Hamming weight of all possible states is the same value, the determination circuit 156 can use the same value as the Hamming weight of the original post-transition state. Therefore, the determination circuit 156 can execute all determinations with a simple configuration.

The determination circuit 156 may execute the following determination instead of comparing the Hamming weight of the actual post-transition state with the Hamming weight of the original post-transition state. The determination circuit 156 calculates the difference between the Hamming weight of the pre-transition state and the Hamming weight of the post-transition state.

If the Hamming distance by which the counter circuit 155 transitions the state is even, the determination circuit 156 determines whether the calculated difference is even. If the calculated difference is even, the determination circuit 156 judges that the state transition was made correctly. On the other hand, if it is determined that the calculated difference is odd, the determination circuit 156 judges that the state transition was made improperly.

On the other hand, if the Hamming distance by which the counter circuit 155 transitions the state is odd, the determination circuit 156 determines whether the calculated difference is odd. If the calculated difference is odd, the determination circuit 156 judges that the state transition was made correctly. On the other hand, if it is determined that the calculated difference is even, the determination circuit 156 judges that the state transition was made improperly.

When the state transition is made correctly, the parity of the Hamming distance by which the counter circuit 155 transitions the state and the parity of the difference in Hamming weight before and after the transition match. However, when the state transition is made improperly, there may be a case where the parity of the Hamming distance by which the counter circuit 155 transitions the state and the parity of the difference in Hamming weight before and after the transition do not match. In this way, by executing the determination of the Hamming weight, the determination circuit 156 can more accurately judge the validity of certification in the semiconductor device H2.

The determination circuit 156 may execute the determination of the calculated Hamming distance and the determination of the Hamming weight each time each of the comparators 154A to 154D outputs a comparison result flag. In another example, the determination circuit 156 executes the determination of the calculated Hamming distance and the determination of the Hamming weight when some of the comparators 154A to 154D output a comparison result flag. The determination circuit 156 executes either the determination of the calculated Hamming distance or the determination of the Hamming weight when another comparator 154 outputs a comparison result flag.

### Third Embodiment

### Description of Configuration

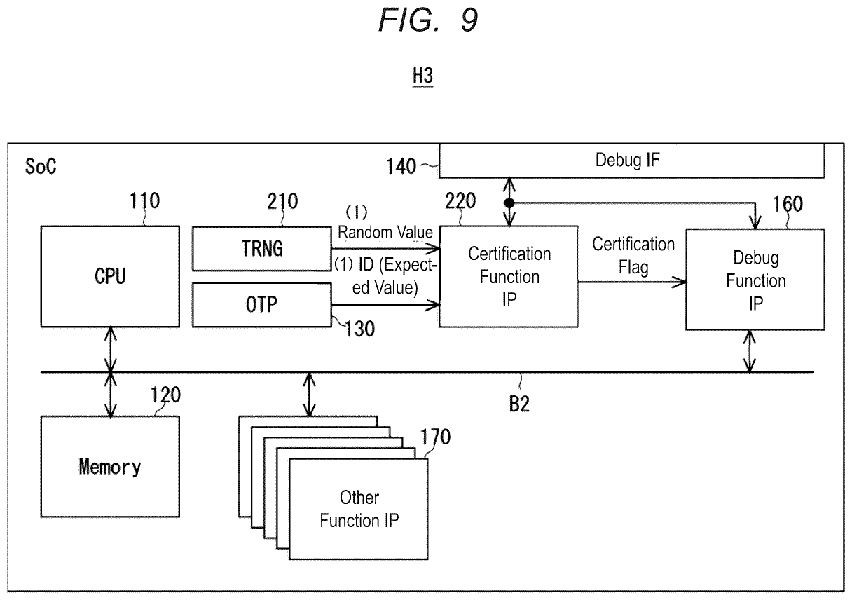

FIG. 9 is a block diagram showing a configuration example of a semiconductor device H3 according to the third embodiment. The semiconductor device H3 includes a CPU 110, a memory 120, an OTP 130, a debug IF 140, a debug function IP 160, other function IP 170, a TRNG (True Random Number Generator) 210, and a certification function IP 220. The descriptions of the CPU 110, the memory 120, the OTP 130, the debug IF 140, the debug function IP 160, and other function IP 170 are omitted as they are the same as those in the second embodiment. Hereinafter, the TRNG 210 and the certification function IP 220, which are unique configurations of the semiconductor device H3, will be described.

The TRNG 210 generates a random value and outputs the random value to the certification function IP 220. However, instead of the TRNG, another type of random number generator may be used. The certification function IP 220 uses the random value received from the TRNG 210 to determine the divided bit length of the input ID value and the ID expected value to be compared.

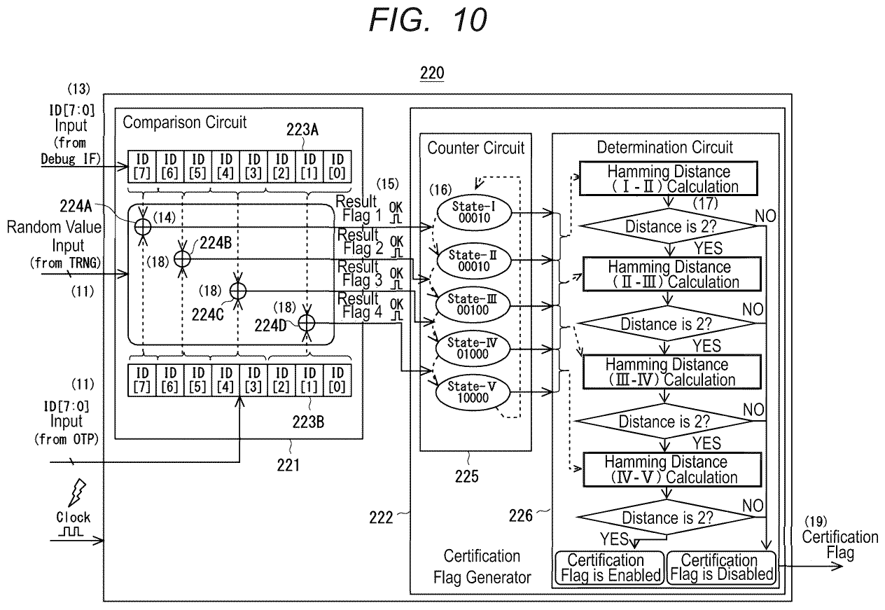

FIG. 10 is a block diagram showing a configuration example of the certification function IP 220. The certification function IP 220 receives the input ID value, ID expected value, clock signal, and random value. The certification function IP 220 includes a comparison circuit 221 and a certification flag generator 222.

The comparison circuit 221 includes memories 223A and 223B, and comparators 224A to 224D. The input ID value from the debug IF 140 is input to the memory 223A. The ID expected value from the OTP 130 is input to the memory 223B. The memory 223A stores the ID expected value for each bit number. The memory 223B stores the ID expected value for each bit number.

The certification function IP 220 determines the bit length of the input ID value and the ID expected value to be compared for each comparator 224 using the random value. The certification function IP 220 determines the divided bit length of each comparator 224 according to the random value by referring to a table stored inside the certification function IP 220, for example. FIG. 10 shows an example where each bit value of the input ID value and the ID expected value is divided into “1 bit”, “2 bits”, “2 bits”, and “3 bits” by the random value.

Specifically, the bit of bit number [7] in the memory 223A and the bit of bit number [7] in memory 223B are input to the comparator 224A. The bits of bit numbers [6] and [5] in the memory 223A and the bits of bit numbers [6] and [5] in the memory 223B are input to the comparator 224B. The bits of bit numbers [4] and [3] in the memory 223A and the bits of bit numbers [4] and [3] in the memory 223B are input to comparator 224C. The comparator 224A receives the bits of bit numbers [2], [1], and [0] in the memory 223A, and the bits of bit numbers [2], [1], and in the memory 223B as inputs.

The comparator 224A compares the 3-bit value of the input ID value with the 3-bit value of the expected ID value. If each input bit value matches, the comparator 224A transfers a comparison result flag indicating an assert to the certification flag generator 222. If each input bit value does not match, the comparator 224A transfers a comparison result flag indicating a negate to the certification flag generator 222. Each comparator 224 other than comparator 224A also compares the bit value of the input ID value with the bit value of the expected ID value. Then, if each input bit value matches, each comparator 224 transfers a comparison result flag indicating an assert to the certification flag generator 222. If each input bit value does not match, each comparator 224 transfers a comparison result flag indicating a negate to the certification flag generator 222.

As described above, by using random values, the split bit length of the input ID value and the ID expected value to be compared is determined randomly. In other words, the comparison points of the input ID value and the ID expected value in each comparator 224 are randomly specified by the random values.

The certification flag generator 222 includes a counter circuit 225 and a determination circuit 226. The operation of the counter circuit 225 and the determination circuit 226 is the same as the operation of the counter circuit 155 and the determination circuit 156 in the second embodiment, and thus the explanation is omitted.

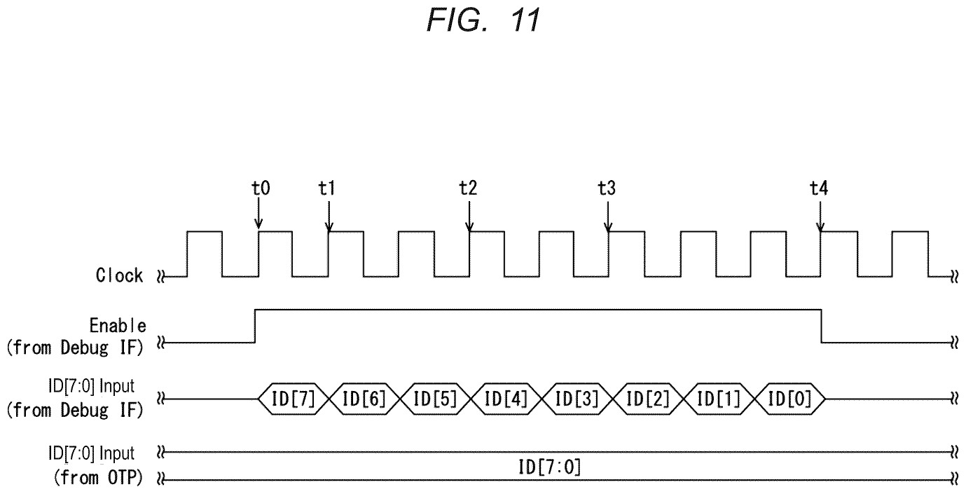

FIG. 11 is a timing chart showing the operation of the semiconductor device H3. Below, the operation of the semiconductor device H3 along the time series will be described with reference to FIGS. 10 and 11. (11) to (19) in FIG. 10 correspond to the codes (11) to (19) below. Note that the operation of each part that has already been described is omitted as appropriate.

(11) First, the power supply of the semiconductor device H3 is activated. A clock signal for operation is supplied to the semiconductor device H3. After the power supply is activated, the ID expected value stored in the OTP 130 is loaded into the certification function IP 220. The ID expected value is stored in the memory 223A. Furthermore, the random value generated by the TRNG 210 is loaded into the certification function IP 220.

(12) The certification function IP 220 determines the split bit length of the input ID value and the ID expected value to be compared by each comparator 224 according to the random value. In this example, the split bit length of the input ID value and the ID expected value to be compared by each comparator 224 is “1 bit,” “2 bits,” “2 bits,” and “3 bits.”

(13) Additionally, the input ID value is input to the certification function IP 220 via the debug IF 140. After timing t0 in FIG. 11, the enable signal for loading from the debug IF 140 to the memory 223B is turned on. In response to the enable signal being turned on, the input ID value is stored in the memory 223B in bit order.

(14) Each bit value of the input ID value and each bit value of the corresponding ID expected value are input to the comparator 224 of the certification function IP 220 for each clock. From timing t0 to t1, the 1-bit value of the input ID value and the 1-bit value of the corresponding ID expected value are input to the comparator 224A. The comparator 224A compares the input 1-bit values at timing t1.

(15) If the input bit values match, the comparator 224A transfers a comparison result flag (assert flag A) indicating an assert to the certification flag generator 222. If the input data does not match, the comparator 224A transfers a comparison result flag indicating a negate to the certification flag generator 222.

(16) When the counter circuit 225 receives the assert flag A, it transitions the state from state I “00001” to state II “00010,” which is a Hamming distance of “2” away. The counter circuit 225 outputs the information of state II to the determination circuit 226. Note that the information of state I, which is the initial state, is stored in the determination circuit 226 in advance.

(17) The determination circuit 226 receives the information of state II as the information of the state after the transition from the counter circuit 225. The determination circuit 226 calculates the Hamming distance between state I, which is the state before the transition, and state II, which is the state after the transition. The determination circuit 226 determines whether the calculated Hamming distance is 2. The detailed explanation of the determination is omitted as it is described in (6) of the second embodiment.

(18) Assuming that the state transition is determined to be normal in (17), comparator 224B performs the same processing as the processing of comparator 224A shown in (14) and (15). Comparator 224B compares the input 2-bit values at timing t2. Subsequently, counter circuit 225 performs the same processing as shown in (16) in response to receiving the assert flag B. The determination circuit 226 performs the same processing as shown in (17) when it receives the information of state III as the information of the state after the transition. The same processing as shown in (14) to (17) is executed for comparators 224C and 224D. Comparator 224C compares the input 2-bit values at timing t3. Additionally, comparator 224D compares the input 3-bit values at timing t4.

Note that after timing t4, the enable signal for loading from the debug IF 140 to the memory 223B is turned off. In response to the enable signal being turned off, the storage of the input ID value in the memory 223B is stopped.

When the processing of (18) is executed for the comparator 224D, the determination circuit 226 calculates the Hamming distance between state IV, which is the state before the transition, and state V, which is the state after the transition. The determination circuit 226 determines whether the calculated Hamming distance is 2. If it is determined that the Hamming distance is 2, the determination circuit 226 determines that the certification flag is valid. On the other hand, if it is determined that the Hamming distance is not 2, the determination circuit 226 determines that the state transition is invalid.

(19) If it is determined that the certification flag is valid, the certification function IP 220 outputs an assert as the certification flag. On the other hand, if it is determined that the certification flag is invalid, the certification function IP 220 outputs a negate as the certification flag. As shown in (8) of the second embodiment, the debug function IP 160 sets permission or prohibition of entry to the debug function according to the certification flag.

### Explanation of Effects

As shown above, the semiconductor device H3 includes TRNG 210, which randomly determines the predetermined bit length for dividing each of the input ID value and the ID expected value. Since the bit length used for division changes dynamically, it becomes difficult for an attacker to predict effective attack points in the comparison between the input ID value and the ID expected value. Therefore, the semiconductor device H3 can further improve its resistance to physical attacks.

Although the invention made by the present inventor has been specifically described based on the embodiment, it is needless to say that the present invention is not limited to the above-described embodiment and various modifications can be made without departing from the gist thereof. For example, it goes without saying that various variations of the semiconductor device H2 described in the second embodiment can also be applied to the semiconductor device H3.

What is claimed is:

1. A semiconductor device comprising:
a transition circuit that transitions a state by a predetermined Hamming distance according to a comparison result of a certification target value and a reference value; and
a determination circuit that determines a validity of the certification by determining whether a Hamming distance between a state before transition and a state after transition matches the predetermined Hamming distance.

2. The semiconductor device according to claim 1, further comprising a plurality of comparators that divide each of the certification target value and the reference value into a predetermined bit length, and compare the divided bit values of the certification target value with the divided bit values of the reference value corresponding to the divided bit values of the certification target value,
wherein the transition circuit transitions the state by a predetermined Hamming distance according to the comparison result for each bit value.

3. The semiconductor device according to claim 2, further comprising a random number generator that randomly determines the predetermined bit length for dividing each of the target value and the reference value.

4. The semiconductor device according to claim 1,
wherein the determination circuit determines the validity of the certification by further using the Hamming weight of the state after transition.

5. The semiconductor device according to claim 4,
wherein the determination circuit determines the validity of the certification by further determining whether the Hamming weight of the actual state after transition and the Hamming weight of the original state after transition are identical.

6. The semiconductor device according to claim 4,
wherein the predetermined Hamming distance is even, and the determination circuit determines the validity of the certification by further determining whether the difference between the Hamming weight of the state before transition and the Hamming weight of the state after transition is even.

7. The semiconductor device according to claim 4,
wherein the predetermined Hamming distance is odd, and the determination circuit determines the validity of the certification by further determining whether the difference between the Hamming weight of the state before transition and the Hamming weight of the state after transition is odd.

8. The semiconductor device according to claim 1,
wherein the predetermined Hamming distance is 2 or more.

9. A certification method for a semiconductor device, comprising:
transitioning a state by a predetermined Hamming distance according to the comparison result of a certification target value and a reference value; and
determining the validity of the certification by determining whether the Hamming distance between the state before transition and the state after transition matches the predetermined Hamming distance.

10. The certification method according to claim 9,
wherein the semiconductor device divides each of the target value and the reference value into a predetermined bit length, compares the divided bit values of the target value with the divided bit values of the reference value corresponding to the divided bit values of the target value, and transitions the state by a predetermined Hamming distance according to the comparison result for each bit value.

11. The certification method according to claim 9,
wherein the semiconductor device randomly determines the predetermined bit length for dividing each of the target value and the reference value.

12. The certification method according to claim 9,
wherein the semiconductor device determines the validity of the certification by further using the Hamming weight of the state after transition.

13. The certification method according to claim 12,
wherein the semiconductor device determines the validity of the certification by further determining whether the Hamming weight of the actual state after transition and the Hamming weight of the original state after transition are identical.

14. The certification method according to claim 12,
wherein the predetermined Hamming distance is even, and the semiconductor device determines the validity of the certification by further determining whether the difference between the Hamming weight of the state before transition and the Hamming weight of the state after transition is even.

15. The certification method according to claim 12,
wherein the predetermined Hamming distance is odd, and the semiconductor device determines the validity of the certification by further determining whether the difference between the Hamming weight of the state before transition and the Hamming weight of the state after transition is odd.

16. The certification method according to claim 9,
wherein the predetermined Hamming distance is 2 or more.
